(19) United States
(12) Patent Application Publication
(10) Pub. No.: US 2002/0051604 A1
(43) Pub. Date: May 2, 2002

(54) Cross coupler for optical communications equipment

(76) Inventor: Kai Weidlich, Aalen (DE)

Correspondence Address: Walter Ottesen, Patent Attorney, P.O. Box 4026, Gaithersburg, MD, 20885-4026, US

(21) Appl. No.: 09/984,277

(22) Filed: Oct. 29, 2001

(30) Foreign Application Priority Data
Oct. 27, 2000 (DE) 100 53 498.8

(51) Int. Cl. G02B 6/28; G02B 6/26

(52) U.S. Cl. 385/24; 385/37; 385/18

(57) ABSTRACT

The invention is directed to a cross coupler for optical communications equipment for wavelength-selectively coupling a plurality of optical input channels to a plurality of optical output channels. The cross coupler includes a spectrometer and a mirror raster. A number of mirror elements of the mirror array 30 is allocated to each optical input channel. This number of mirror elements corresponds to the number of communications channels selected in accordance with wavelength and transmittable simultaneously to an optical input channel. Correspondingly, a number of mirror elements ia allocated to each optical output channel and this number of mirror elements correspond to the number of communications channels separated by wavelength and transmittable simultaneously for optical output channels.

### FIELD OF THE INVENTION

The invention relates to a cross coupler or a so-called optical cross connect for optical communications equipment for wavelength-selective coupling a plurality of optical input channels to a plurality of optical output channels.

### BACKGROUND OF THE INVENTION

In optical communications technology, the problem is present that a plurality of optical input channels are to be coupled selectively to a plurality of optical output channels. The input channels are realized usually in the form of a plurality of glass fibers and the output channels are likewise realized as a plurality of glass fibers. What is difficult here is that a plurality of communications channels are realized on each of the optical input and output channels because of the use of corresponding frequency bands. At the present time, the communications channels are approximately 100 in number. Accordingly, the need is present to also configure the coupling of each individual optical input channel wavelength selectively to each desired optical output channel so that each desired input communications channel can be coupled to each desired output communications channel.

### SUMMARY OF THE INVENTION

In view of the foregoing, it is an object of the invention to provide a cross coupler which overcomes the above disadvantages.

The cross coupler of the invention is for optical communications equipment for selectively coupling light from a plurality of input channels to a plurality of output channels in accordance with wavelength.

The cross coupler of the invention includes: a spectrometer for selectively deflecting the light on the basis of the wavelength; and, a mirror raster having a plurality of individually adjustable mirror elements for reflecting the light from the spectrometer in dependence upon the wavelength.

According to another feature of the invention, a mirror is provided in the beam path rearward of the mirror raster.

In the cross coupler of the invention, a separate mirror element of the mirror raster is assigned to each communications channel. If as no mirror rasters having an adequate number of separately drivable mirror elements are available, several mirror rasters can be provided arranged parallel to each other. In this context, it is conceivable that the number of mirror rasters corresponds to the number of communications channels which are realized each by individual optical input and output channels according to wavelength. The number of the mirror elements of each mirror raster then corresponds to the sum of the number of input channels and output channels, which are realized optically separate.

In an advantageous embodiment, the light, which exits from an input channel, passes for a first time through the component system comprising spectrometer and mirror array in advance of incidenting upon the mirror for a first time and a second time after reflection on the mirror. With the second incidence on the mirror array, the beam impinges on another mirror element of the mirror array which is assigned to the desired optical output channel so that, after a second run through through the spectrometer, the light incidents upon the desired outlet channel.

### BRIEF DESCRIPTION OF THE DRAWINGS

The invention will now be described with reference to the drawings wherein:

FIG. 1 is a section view through a cross coupler of the invention in a plane containing the dispersive direction of the spectrometer;

FIG. 2 is a section view through the cross coupler of the invention in a sectioning plane perpendicular to FIG. 1;

FIG. 3 is an alternate embodiment of the cross coupler of the invention shown in section; and,

FIG. 4 is a further alternate embodiment of a cross coupler of the invention.

### DESCRIPTION OF PREFERRED EMBODIMENTS OF THE INVENTION

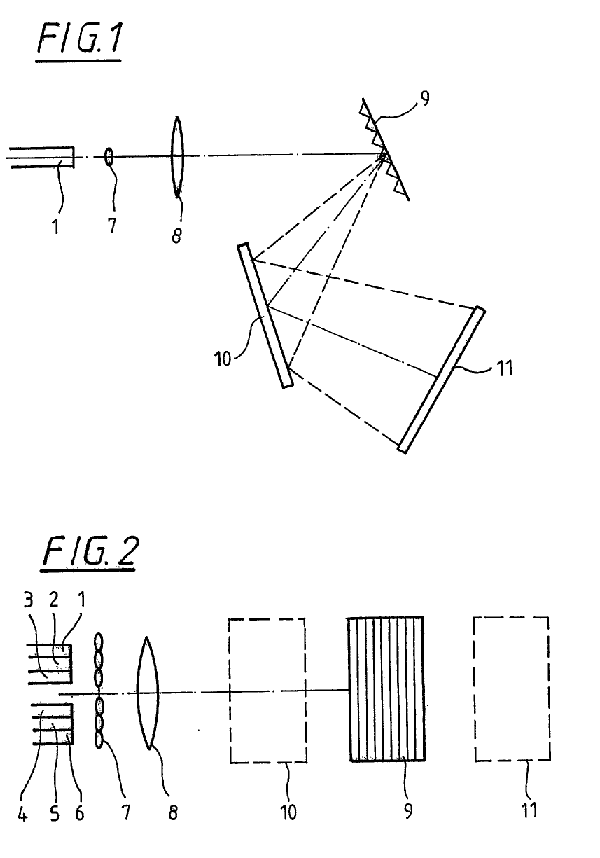

The cross coupler shown in FIGS. 1 and 2 functions to selectively couple a plurality of optical input channels (1 to 3) to a plurality of optical output channels (4 to 6). For clarity, of the optical input and output channels, only three of each are shown in FIG. 2; whereas, in a practical embodiment, the number of input and output channels would amount to at least 10,000 and preferably even over 1 million for each case.

The cross coupler can have a lens array 7 which has individual lenses for each of the input and output channels 1 to 6. The lens array 7 is connected directly forward of the input and output channels. Each individual lens of the lens array 7 functions together with an imaging optic 8 for the purpose that the aperture of the light emitted from the assigned optical input channel is adapted to the area size of the assigned mirror element of the mirror array 10 and the light, which is reflected back to the optical output channel to be coupled, is likewise adapted to the aperture of the optical output channel.

An optic element 8 follows the lens array 7 and has a diameter so selected that the diameter of this imaging optic 8 overlaps the diameter of the lens array 7.

A spectrometer 9 follows the imaging optic 8 and functions to split the incident light selectively on the basis of wavelength. A mirror array 10 follows the spectrometer 9 in beam direction and has a plurality of individual mirrors which can be switched independently of each other. Corresponding mirror arrays are, for example, so-called micromirror devices obtainable from the Texas Instruments Company. The number of individual mirrors of this mirror array 10 corresponds to the number of communications channel which are to be coupled to each other. For example, if there are 100 optical input channels to be coupled to 100 optical output channels and, if each optical input and output channel has ten transmission channels separated according to wavelength, then the mirror array 10 has (100+100)×10 individual mirror elements. A number of individual mirrors of the mirror array 10 is correspondingly assigned to each input channel and to each output channel. This number of individual mirrors corresponds to the number of transmission channels of each optical input and output channel separated in accordance to wavelength.

Viewed in the direction of the light, a large-area mirror 11 follows the mirror array 10 and the light, which is deflected by the mirror array 10 is again reflected back by mirror 11 to the mirror array 10 so that thereafter the light, which is reflected back at mirror 11, runs through the arrangement of the mirror array 10, spectrometer 9, and imaging optic 8 a second time.

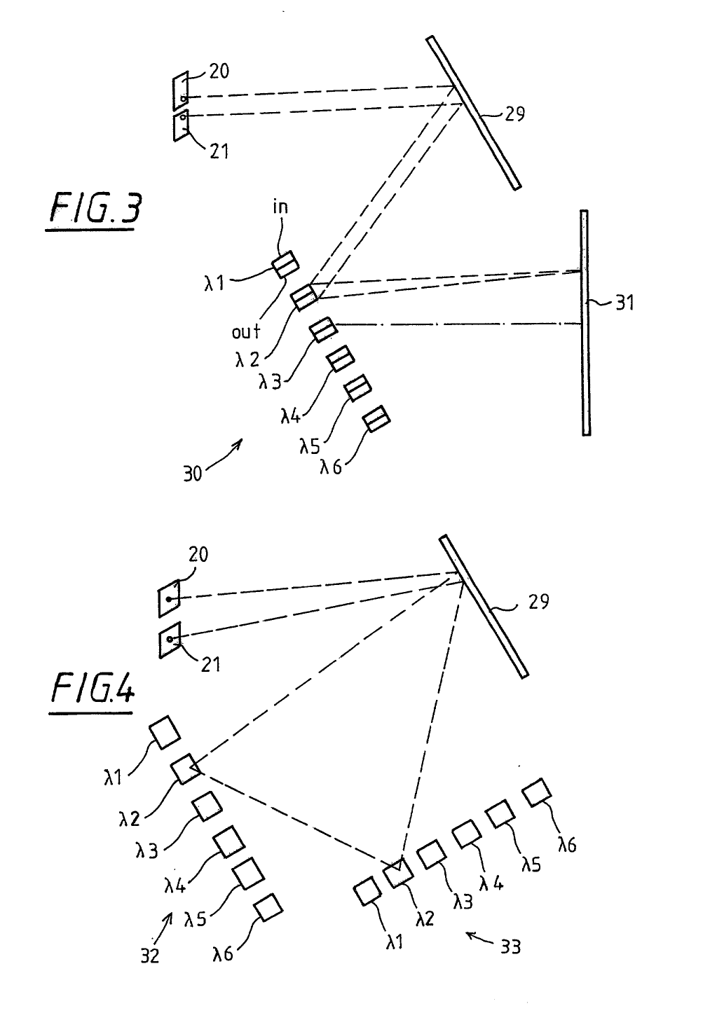

The operation of the cross coupler according to the invention can be explained best with respect to the schematic of FIG. 3.

An input terminal 20 has a plurality of optical input channels which are not shown individually in FIG. 3 and these input channels are to be coupled to a plurality of optical output channels of an output terminal 21. A separate mirror array λ₁ to λ₆ is provided behind the grating 29 for each transmission channel separated in accordance with wavelength, that is, for each wavelength band defining a communications channel. Each of the mirror arrays (λ₁ to λ₆) has a number of individually drivable individual mirrors which corresponds precisely to the sum of the optical input channels of the input terminal 20 and the optical output channels of the output terminal 21. Alternatively thereto, an individual micromirror array 30 can be provided whose number of individually drivable individual mirrors corresponds precisely to the product of the number of communications channels (separated in accordance to wavelength) per optical input and output channel on the one hand and the sum of the optical input channels and the optical output channels on the other hand. Each optical input channel of the input terminal 20 is correspondingly assigned a separate mirror element of the mirror array 30 for each one of the wavelength bands defining a communications channel. Correspondingly, a separate mirror element of the mirror array 30 is assigned to each optical output channel of the output terminal 21 for each wavelength band defining a communications channel. This allocation is fixedly pregiven and stored and is considered as set forth below for the tilting of the individual mirror elements in dependence upon which of the optical transmission channels for which wavelength band are to be coupled to each other.

A signal can be assumed coming in at a wavelength λ₂ on a special glass fiber, that is, a special optical input channel of the input terminal 20. Assume further that this signal is to be coupled to a special optical output channel of the output terminal 21. The dispersive action of the grating 29 ensures that the signal, which is to be coupled, impinges on the mirror element of the mirror array 30 assigned to the wavelength λ₂ and the appropriate optical input channel. The tilt angle of this mirror element is now so adjusted that, after reflection at this mirror element and subsequent reflection at mirror 31, the signal, which is to transmitted, impinges on the mirror element assigned to the same wavelength but to the optical output channel which is to be coupled. This mirror element assigned to the optical output channel is now tilted so that it deflects back the signal, which is to be coupled, via the grating 29 onto the desired optical output channel of the output terminal 21. The deflection of the individual mirror elements is thereby dependent upon the wavelength of the signal, which is to be transmitted, as well as upon the optical input and output channels, which are to be coupled to each other.

Alternative to the use of a mirror 31, it would also be conceivable to provide a beam path, which is mirrored essentially at the mirror 31, that is, to essentially arrange the optical input channels 20 and the optical output channels 21 opposite each other and to split the mirror elements of the mirror array 30 into two mirror arrays. Such a system would, however, require a second grating and would be built substantially less compact.

A further alternate embodiment is shown in FIG. 4. In contrast to the embodiment of FIG. 3, two mirror arrays (32, 33) are provided here of which one is allocated to the input channels of the input terminal 20 and the second is allocated to the output channels of the output terminal 21. Each of the two mirror arrays (32, 33) includes exactly half as many individually adjustable mirror elements as the mirror array 30 in FIG. 3. For this separate arrangement of the two mirror arrays, the light, which comes from an optical input channel, is reflected directly by the mirror element of the first mirror array 31 onto the mirror element of the second mirror array 32 and is guided by this mirror element directly via the grating 29 to the particular output channel without the interposition of an additional mirror. The mirror element of the first mirror array 31 is allocated to the corresponding input channel and the mirror element of the second mirror array 32 is allocated to the output channel with which the coupling is to be established.

The spectrometer can be configured as a diffraction grating in all of the embodiments described herein.

It is understood that the foregoing description is that of the preferred embodiments of the invention and that various changes and modifications may be made thereto without departing from the spirit and scope of the invention as defined in the appended claims.

What is claimed is:

1. A cross coupler for optical communications equipment for selectively coupling light from a plurality of input channels to a plurality of output channels in accordance with wavelength, the cross coupler comprising:
a spectrometer for selectively deflecting said light on the basis of said wavelength; and,
a mirror raster having a plurality of individually adjustable mirror elements for reflecting the light from said spectrometer in dependence upon said wavelength.

2. The cross coupler of claim 1, further comprising a mirror disposed downstream of said mirror raster for reflecting said light back to said mirror raster.

3. The cross coupler of claim 2, further comprising a plurality of said mirror rasters.

4. The cross coupler of claim 3, wherein a plurality of communications channels are provided in accordance with wavelength for each one of said input and output channels; and, the number of said mirror rasters corresponds to the number of said communications channels.

5. The cross coupler of claim 1, wherein a plurality of communications channels are provided in accordance with wavelength for each one of said input and output channels; and, said mirror raster includes a plurality of mirror elements corresponding to the number of said communications channels multiplied by the sum of said optical input and output channels.

6. The cross coupler of claim 2, wherein said spectrometer and said mirror array conjointly define a component system; and, wherein said light, before incidenting on said mirror, passes a first time through said component system and, after reflection at said mirror, passes through said component system a second time.

7. The cross coupler of claim 1, further comprising a lens array arranged on said optical axis.

8. The cross coupler of claim 7, wherein the number of lenses of said lens array corresponds to the sum of the number of input channels and output channels to be coupled to each other.
